(19) United States
(12) Patent Application Publication
(10) Pub. No.: US 2025/0086269 A1
(43) Pub. Date: Mar. 13, 2025

(54) SYSTEM AND METHOD FOR MANAGING MEMORY, AND ELECTRONIC DEVICE

(71) Applicant: MONTAGE TECHNOLOGY CO., LTD., Shanghai (CN)

(72) Inventors: Liangliang NIU, Shanghai (CN); Yi LI, Shanghai (CN)

(73) Assignee: MONTAGE TECHNOLOGY CO., LTD., Shanghai (CN)

(21) Appl. No.: 18/826,147

(22) Filed: Sep. 5, 2024

(30) Foreign Application Priority Data
Sep. 8, 2023 (CN) 2023111648799

(51) Int. Cl. G06F 21/54; G06F 21/55; G06F 21/76

(52) U.S. Cl. CPC G06F 21/54; G06F 21/554; G06F 21/76

(57) ABSTRACT

A system and a method for managing a memory, and an electronic device are provided. The system comprises a memory allocator and a trusted driving module. The memory allocator receives a first memory access request for a target partition of the memory and obtains authentication information to generate an authentication request. The memory allocator manages one or more physical memory partitions of the memory, and the target partition is one of the physical memory partitions. The trusted driving module is configured to receive the authentication request, generate an authentication result, and return the authentication result to the memory allocator. The memory allocator is further configured to execute the first memory access request when the authentication result indicates that the authentication succeeds, and reject the first memory access request when the authentication result indicates that the authentication fails. The system of the present disclosure enhances the security of memory operating.

### FIELD OF THE INVENTION

The present disclosure belongs to the field of storage technologies, and relates to a management system, in particular to a system for managing a memory, a method for managing the memory, and an electronic device.

### BACKGROUND OF THE INVENTION

Memory serves as a critical component in electronic devices, often referred to as internal storage or main memory. Its primary function is to temporarily hold computational data and program code for the processor, as well as data exchanged with external storage such as hard drives. Memory acts as the conduit between the external storage and the processor. Most program execution within electronic devices occurs in memory, and therefore, safeguarding data stored in memory, especially sensitive data, is of utmost importance. However, when it comes to external memory access, the memory itself cannot differentiate between legitimate and illegitimate memory access requests, nor can it discern the sensitivity of the data. This vulnerability allows malicious users to potentially access or modify sensitive data once they breach the memory.

### SUMMARY OF THE INVENTION

The present disclosure provides a system for managing a memory, a method for managing the memory, and an electronic device, which enhance the security of memory data.

A first aspect of the present disclosure provides a system for managing a memory. The system comprises a memory allocator and a trusted driving module. The memory allocator is configured to receive a first memory access request for a target partition of the memory and obtain authentication information to generate an authentication request. The memory allocator manages one or more physical memory partitions of the memory, and the target partition is one of the physical memory partitions. The trusted driving module is configured to receive the authentication request, generate an authentication result based on the authentication information and external authorization information, and return the authentication result to the memory allocator. The memory allocator is further configured to execute the first memory access request when the authentication result indicates that the authentication succeeds, and reject the first memory access request when the authentication result indicates that the authentication fails.

In one embodiment of the first aspect, the system further comprises a device driving module. The device driving module configures a protection rule for each of the physical memory partitions to limit access to the physical memory partitions.

In one embodiment of the first aspect, the system further comprises a secure memory module. The trusted driving module is further configured to invoke an interface of the device driving module and send a first key stored in the trusted driving module to the device driving module when the authentication result indicates that the authentication succeeds. The device driving module is configured to determine if the first key matches a second key stored in the secure memory module, and disable a protection rule of the target partition when the first key matches the second key.

In one embodiment of the first aspect, the secure memory module is further configured to update, after the first key matches the second key, the second key to obtain an updated second key.

In one embodiment of the first aspect, the trusted driving module is further configured to invoke the interface of the device driving module after the memory allocator finishes executing the first memory access request to notify the device driving module to re-enable the protection rule of the target partition, and update the first key based on the updated second key.

In one embodiment of the first aspect, the system further comprises a secure memory module. The secure memory module is configured to receive a second memory access request for the target partition, detect whether a conflict exists between the second memory access request and a protection rule of the target partition, and reject the second memory access request when detecting that the conflict exists. The second memory access request is not from the memory allocator.

In one embodiment of the first aspect, the secure memory module is further configured to generate an illegal access record when detecting that the conflict exists.

In one embodiment of the first aspect, the protection rules comprise one or more of: data reads from the physical memory partition are disabled, data writes to the physical memory partition are disabled, and accesses to the physical memory partition are monitored.

A second aspect of the present disclosure provides a method applied to a system for managing a memory. The system comprises a memory allocator and a trusted driving module. The memory allocator manages one or more physical memory partitions of the memory. The method comprises: receiving, by the memory allocator, a first memory access request for a target partition and obtaining authentication information to generate an authentication request, where the target partition is one of the physical memory partitions; sending, by the memory allocator, the authentication request to the trusted driving module; generating, by the trusted driving module, an authentication result based on the authentication information of the authentication request and external authorization information, and returning the authentication result to the memory allocator; executing, by the memory allocator, the first memory access request when the authentication result indicates that the authentication succeeds, and rejecting the first memory access request when the authentication result indicates that the authentication fails.

In one embodiment of the second aspect, the system further comprises a device driving module, and the method further comprises: configuring, by the device driving module, a protection rule for each of the physical memory partitions to limit access to the physical memory partitions.

In one embodiment of the second aspect, the system further comprises a secure memory module, and the method further comprises: invoking, by the trusted driving module, an interface of the device driving module and sending a first key stored in the trusted driving module to the device driving module when the authentication result indicates that the authentication succeeds; determining, by the device driving module, if the first key matches a second key stored in the secure memory module, and closing a protection rule of the target partition when the first key matches the second key.

In one embodiment of the second aspect, the method further comprises: updating, by the secure memory module, the second key to obtain an updated second key after the first key matches the second key.

In one embodiment of the second aspect, the method further comprises: invoking, by the trusted driving module, the interface of the device driving module after the memory allocator finishes executing the first memory access request to notify the device driving module to re-enable the protection rule of the target partition, and updating the first key based on the updated second key.

In one embodiment of the second aspect, the system further comprises a secure memory module, and the method further comprises: receiving, by the secure memory module, a second memory access request for the target partition, detecting whether a conflict exists between the second memory access request and a protection rule of the target partition, and rejecting the second memory access request when detecting that the conflict exists, where the second memory access request is not from the memory allocator.

In one embodiment of the second aspect, the method further comprises: generating, by the secure memory module, an illegal access record when detecting that the conflict exists.

A third aspect of the present disclosure provides an electronic device, and the electronic device comprises a memory and a processor. A computer program is stored on the memory. The processor is communicatively connected to the memory and is configured to invoke the computer program to perform a method applied to a system for managing the memory. The system comprises a memory allocator and a trusted driving module, the memory allocator manages one or more physical memory partitions of the memory, and the method comprises: receiving, by the memory allocator, a first memory access request for a target partition and obtaining authentication information to generate an authentication request, where the target partition is one of the physical memory partitions; sending, by the memory allocator, the authentication request to the trusted driving module; generating, by the trusted driving module, an authentication result based on the authentication information of the authentication request and external authorization information, and returning the authentication result to the memory allocator; executing, by the memory allocator, the first memory access request when the authentication result indicates that the authentication succeeds, and rejecting the first memory access request when the authentication result indicates that the authentication fails.

The present disclosure introduces the concept of “partition” management, where a specific portion of a physical memory is managed separately. By implementing protection rules, identity authentication, and encryption keys, the data stored in this specific memory region (referred to as the target partition) benefits from both software and hardware-based security mechanisms, preventing unauthorized users from accessing or modifying the data. Additionally, any unauthorized access attempts can be monitored and recorded. Overall, this method transforms the memory devices from passive components to actively secured elements, significantly enhancing memory security.

### BRIEF DESCRIPTION OF DRAWINGS

FIG. 1A shows a schematic structural diagram of an electronic device according to an embodiment of the present disclosure.

FIG. 1B shows a flowchart of a method for managing a memory according to an embodiment of the present disclosure.

FIG. 1C shows a schematic diagram of an application scenario of the method for managing the memory according to an embodiment of the present disclosure.

FIG. 2 shows a flowchart of a method for managing the memory according to another embodiment of the present disclosure.

FIG. 3 shows a schematic diagram of authorization information according to an embodiment of the present disclosure.

FIG. 4 shows a flowchart illustrating a response of a secure memory module to a memory access request according to an embodiment of the present disclosure.

FIG. 5 shows a schematic diagram of an electronic device according to another embodiment of the present disclosure.

### DETAILED DESCRIPTION OF THE INVENTION

The embodiments of the present disclosure will be described below. Those skilled can easily understand other advantages and effects of the present disclosure according to contents disclosed by the specification. The present disclosure can also be implemented or applied through other different specific embodiments. Various details in this specification can also be modified or changed based on different viewpoints and disclosures without departing from the spirit of the present disclosure. It should be noted that the following embodiments and features of the following embodiments can be combined with each other if no conflict will result.

It should be noted that the drawings provided in this disclosure only illustrate the basic concept of the present disclosure in a schematic way, so the drawings only show the components closely related to the present disclosure. The drawings are not necessarily drawn according to the number, shape and size of the components in actual implementation; during the actual implementation, the type, quantity and proportion of each component can be changed as needed, and the layout of the components can also be more complicated.

In electronic devices, the data required for processor execution is primarily stored in memory. Such data may include sensitive information such as identity details, keys, and session tokens. In certain technical solutions, processors provide security features to safeguard sensitive data within memory. However, memory itself is a passive storage device, and cannot discern the sensitivity of the data, nor can it differentiate between legitimate and illegitimate memory access requests. Consequently, when system vulnerabilities exist and are exploited by unauthorized users, the memory device cannot distinguish between legitimate and illegitimate data access or modification requests. Regardless of whether the request comes from a legitimate or unauthorized user, the memory device will respond and either return or update the data, potentially leading to sensitive data leaks and compromising data security of the system.

Additionally, from the operating system's perspective, all memory resources are treated equally, and they are fairly distributed among application processes. When handling user requests for memory allocation, the operating system randomly assigns physical memory to users. Sensitive user data is therefore typically scattered across different regions of physical memory, further complicating protection measures within memory.

Furthermore, electronic devices may have vulnerabilities, and unauthorized users can exploit these vulnerabilities to access data in memory, posing a threat to data security.

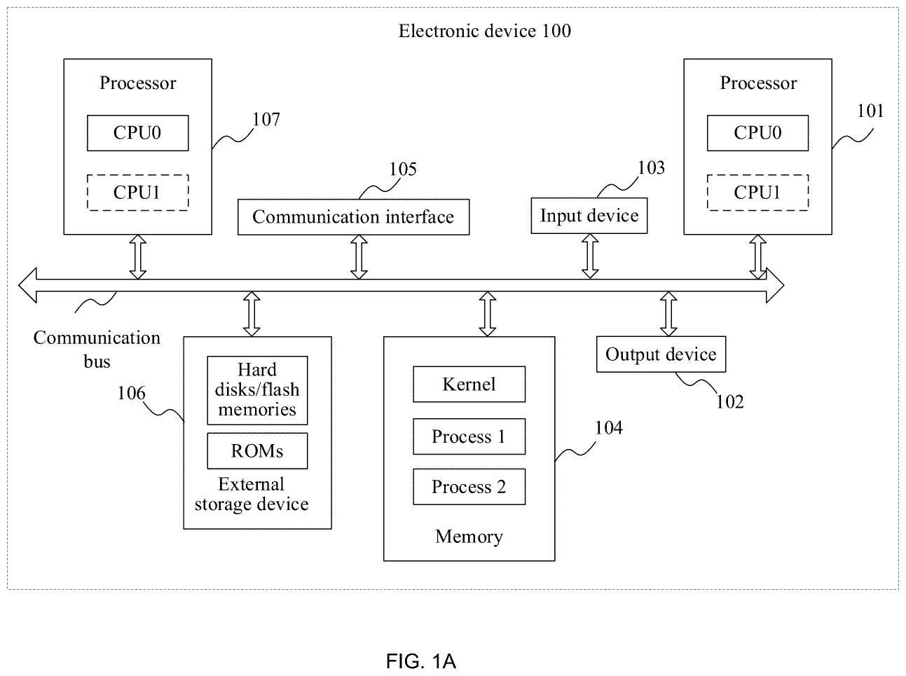

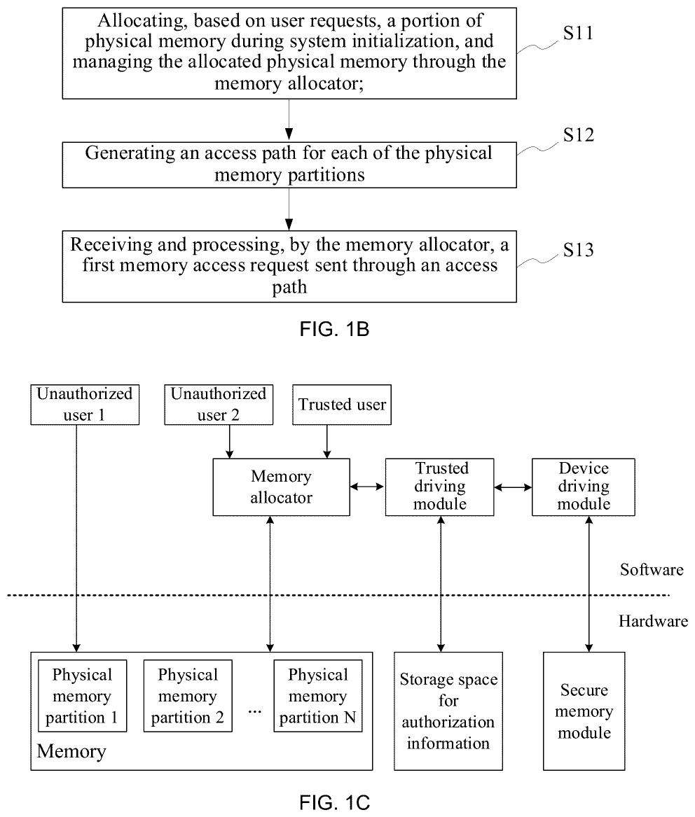

To address these issues, the present disclosure provides a memory allocator, and a system and a method for managing a memory based on the memory allocator. The embodiments of the present disclosure can be applied to electronic devices. FIG. 1A shows a schematic structural diagram of an electronic device 100 according to an embodiment of the present disclosure. As shown in FIG. 1A, the electronic device 100 comprises a processor 101 connected to one or more storage units. The storage units may comprise an external storage device 106 and a memory 104. The external storage device 106 may be either read-only, like read-only memories (ROMs), or read-write, such as hard disks or flash memories. The memory 104 may be random access memories (RAMs). The memory 104 can either be integrated with the processor 101 or exist as an independent component. The processor 101 serves as a control center of the electronic device 100, executing program code to achieve the functionality specified by the program instructions. Optionally, the processor 101 comprises one or more central processing units (CPUs), like CPU0 and CPU1 shown in FIG. 1A. Optionally, the electronic device 100 may comprise more than one such processors, as depicted by processors 101 and 107 shown in FIG. 1A. Both processors 101 and 107 may be single-core or multi-core processors. As used herein, the term “processor” encompasses devices, circuits, and/or processing cores used for handling data such as computer program instructions.

The CPUs of the processors 101 and/or 107 store the executed program code in the memory 104 or the external storage device 106. The program code stored in the external storage device 106 can be copied into the memory 104 so that the processor 101 can execute it. By controlling execution of the program, the processor 101 can manage communication between the electronic device 100 and peripheral devices, as well as allocating resources for the electronic device 100.

The electronic device 100 may further comprise a communication interface 105, and the electronic device 100 may communicate with another device or system through the communication interface 105 or an external network.

Optionally, the electronic device 100 may further comprise an output device 102 and an input device 103. The output device 102 is connected to the processor 101, and can display output information in various ways. In one embodiment, the output device 102 comprises visual displays like liquid crystal displays (LCDs), light-emitting diode (LED) monitors, cathode ray tubes (CRTs), or projectors. The input device 103 is connected to the processor 101, and can receive user input in various ways. Examples of the input device 103 comprise devices like mice, keyboards, touchscreens, or sensors.

In some embodiments, the electronic device 100 may further comprise a secure memory module (not shown), and the secure memory module is configured to protect memory addresses (i.e., configuring protection rules) and can automatically generate and match keys. The protecting of the memory addresses may comprise making a specific memory region read-only, hiding a specific memory region, and recording access (such as read and write operations) to a specific memory region. The generating of the keys involves automatically creating and updating keys for use by administrators or relevant modules. Some or all of the operations of the electronic device 100 require initial key matching; if the matching fails, the electronic device 100 ignores related user operations; and if the matching succeeds, users can interact with the electronic device 100. After completing relevant operations, the administrators or relevant modules can read new keys and store them for subsequent matching.

The foregoing components of the electronic device 100 can be interconnected by one or more communication buses, including data buses, address buses, control buses, expansion buses, and local buses.

The electronic device 100 can be general-purpose or specific-purpose devices. As an example, the electronic device 100 may be storage arrays, application servers, supercomputers, desktop computers, laptops, personal digital assistants (PDAs), mobile phones, tablets, wireless terminals, telecommunications equipment, or any other device with a similar structure as shown in FIG. 1A. The present disclosure is not limited to any particular type of electronic devices.

In the following, the memory allocator, and the system and the method for managing the memory of the present disclosure will be described in further detail.

The memory allocator of the present disclosure can independently manage a portion of physical memory. It collaborates with a trusted driving module to provide software-based protection for data stored in that specific physical memory region. Additionally, it offers an interface with system compatibility for user access. Furthermore, the memory allocator can work in conjunction with the secure memory module (such as hardware modules) within the system to provide hardware-based protection for users.

In some embodiments, referring to FIG. 1B, the method for managing the memory comprises steps S11-S13.

Step S11 includes allocating, based on user requests, a portion of physical memory during system initialization, and managing the allocated physical memory through the memory allocator; wherein the allocated physical memory comprises one or more physical memory partitions.

Specifically, users may partition the physical memory of the memory based on their requirements. In some embodiments, users can reserve a portion of physical memory during system initialization and manage it using the memory allocator, while the remaining physical memory continues to be managed by the operating system. Essentially, the entire physical memory of the memory is divided into two main regions: a physical memory region managed by the memory allocator, and a physical memory region used by the operating system. It should be understood that the physical memory region managed by the memory allocator is not accessible by the operating system; in other words, the physical memory region managed by the memory allocator is invisible to the operating system. To differentiate it from the physical memory region managed by the operating system, the physical memory region managed by the memory allocator will hereinafter be referred to as a secure memory region.

In some embodiments, users can further partition the secure memory region based on their requirements. As shown in FIG. 1C, the secure memory region is divided into N contiguous physical memory partitions (also referred to as “zones”), where N is a positive integer. These partitions can have equal or different sizes. By dividing the secure memory region into multiple physical memory partitions, users can categorize data based on characteristics such as type and security level and store them in different partitions, making data management more efficient.

In one embodiment, users can configure a protection rule for each of the physical memory partitions based on their requirements. These protection rules may comprise one or more of: data reads from the physical memory partition are disabled, data writes to the physical memory partition are disabled, and accesses to the physical memory partition are monitored. In other words, users can use rule configuration to prevent specific types of memory access behavior, protecting the data stored in the secure memory region from unauthorized reading or modification. In some embodiments, when the secure memory region is divided into multiple partitions, users can configure different protection rules for different partitions, providing varying levels of protection for data within different partitions. In some embodiments, users can set protection rules through a software driving module (hereinafter referred to as device driving module) corresponding to the secure memory module.

Step S12 includes generating an access path for each of the physical memory partitions.

Specifically, once the users divide the secure memory region into N partitions, a file system of the memory allocator is set up to initialize each partition and generate a corresponding access path for it, allowing users to directly access a specific partition by following the corresponding access path. In some embodiments, users can specify an access path for each partition during initialization process. In some embodiments, these access paths may be presented as files or file directories, making it convenient for users to interact with the respective partitions.

S13 includes receiving and processing, by the memory allocator, a first memory access request sent through an access path.

Specifically, once the access path is generated, users can send the first memory access request to the memory allocator through this access path, and the memory allocator responds based on the first memory access request. In the following, the detailed response process of the memory allocator will be described.

FIG. 1C shows a schematic diagram of a system for managing the memory according to an embodiment of the present disclosure. As shown in FIG. 1C, the system comprises a memory allocator, a trusted driving module, a device driving module, and a secure memory module. The secure memory module is a hardware module, and the device driving module is a software driving module corresponding to the secure memory module.

Upon receiving the first memory access request, the memory allocator is configured to generate an authentication request and send the authentication request to the trusted driving module for authentication, to determine whether the user has access permission or whether the user is a trusted user.

The trusted driving module is configured to respond to the authentication request from the memory allocator, generate an authentication result, and provide the authentication result back to the memory allocator.

The trusted driving module is further configured to invoke an interface of the device driving module and disable a protection rule of a target partition when the authentication result indicates that the authentication succeeds, and to invoke the interface of the device driving module again after the memory allocator finishes executing the first memory access request to notify the device driving module to re-enable the protection rule of the target partition. The target partition is one of the physical memory partitions corresponding to the first memory access request.

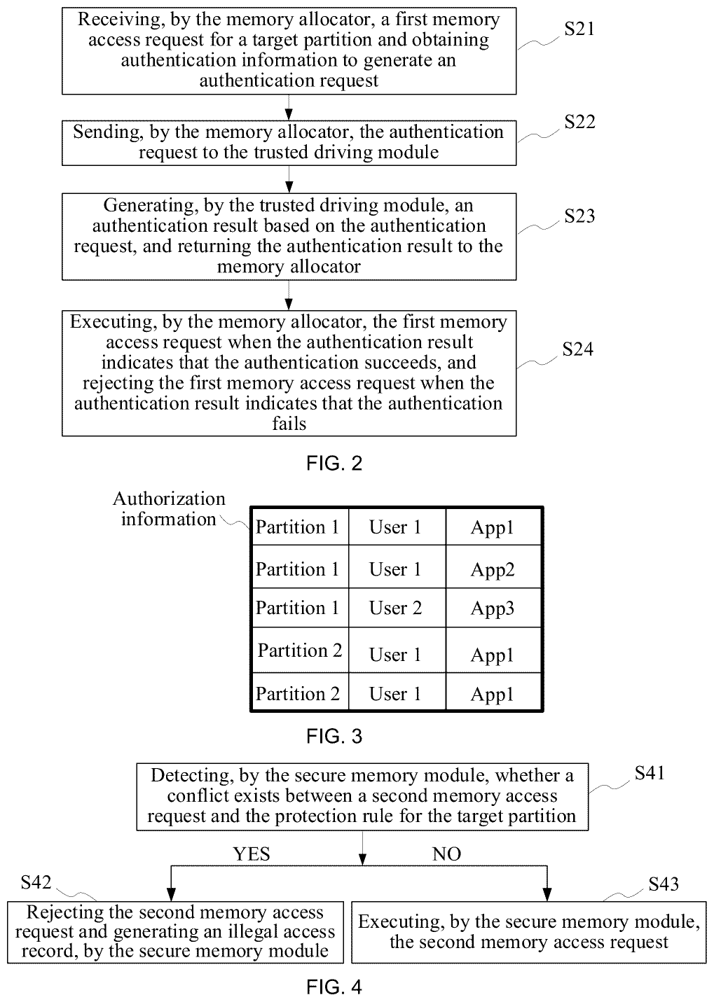

FIG. 2 shows a flowchart of a method for managing the memory according to another embodiment of the present disclosure. The method can be applied to the system shown in FIG. 1C. As shown in FIG. 2, the method for managing the memory comprises steps S21-S24.

Step S21 includes receiving, by the memory allocator, a first memory access request for a target partition and obtaining authentication information to generate an authentication request, where the target partition is one of the physical memory partitions. The first memory access request may be sent by a user through an application.

Step S22 includes sending, by the memory allocator, the authentication request to the trusted driving module.

Upon receiving the first memory access request, the memory allocator can obtain the authentication information and generate the authentication request based on the authentication information. In some embodiments, the authentication information may comprise both user information and process information, where the user information typically consists of identity information of the user who initiates the first memory access request, such as User 1 and User 2 (as depicted in FIG. 3). The process information may comprise information about applications, such as App 1 and App 2 (as depicted in FIG. 3), which initiate the first memory access request. Upon receiving the first memory access request, the memory allocator can obtain the user information and the process information from a kernel of the operating system. In another embodiment, the authentication information may further comprise information of the target partition. Specifically, this information pertains to the partitions associated with the first memory access request, such as Partition 1 and Partition 2 (as depicted in FIG. 3). In yet another embodiment, the authentication information may further comprise operation information. Specifically, the operation information relates to types of operations associated with the first memory access request, such as writing, reading, and similar actions. Furthermore, the operation information and the information of the target partition may be obtained from the first memory access request.

Step S23 includes generating, by the trusted driving module, an authentication result based on the authentication request, and returning the authentication result to the memory allocator.

Specifically, the trusted driving module receives the authentication request from the memory allocator, and generates the authentication result based on the authentication information of the authentication request and external authorization information, to determine whether the user has access permission or whether the user is a trusted user.

In some embodiments, the trusted driving module can obtain the authorization information, and match the authentication information of the authentication request with the authorization information. The authorization information can be stored in a storage space outside the memory, for example, when the memory is a peripheral component interconnect (PCI) device, this storage space may follow a PCI protocol. In some embodiments, the authorization information may comprise authorized user information, authorized program information, authorized partition information, and/or authorized operation information. FIG. 3 illustrates one form of authorization information. In FIG. 3, each row of information represents one piece of permission information, for example, the first row indicates that User 1 has access to Partition 1 through APP 1. The trusted driving module can determine if the authentication information matches one of rows of information shown in FIG. 3; if yes, the user is considered trusted and has access permission; and if no, the user is considered unauthorized and does not have access permission. It should be understood that authorization information for one of the physical memory partitions shown in FIG. 3 is merely illustrative. For example, in some embodiments, users can define finer-grained authorization information, such as whether a specific user or application has read/write permissions for a particular physical memory partition.

Regardless of whether the authentication information matches the authorization information or not, the trusted driving module will return the authentication result to the memory allocator; in other words, when the authentication information fails to match the authorization information, the trusted driving module returns an authentication result indicating unsuccessful authentication to the memory allocator; and when the authentication information matches the authorization information, the trusted driving module returns an authentication result indicating successful authentication to the memory allocator. In some embodiments, the secure memory module is further configured to update the key and perform key matching. Specifically, when the authentication result indicates successful authentication, the trusted driving module further invokes an interface of the device driving module and sends a first key stored in the trusted driving module to the device driving module, so that the device driving module determines if the first key matches a second key stored in the secure memory module, and disables a protection rule of the target partition when the first key matches the second key; therefore, memory access requests from trusted users are not restricted by the protection rule. After key matching is finished, the secure memory module updates the second key for subsequent matching.

Step S24 includes executing, by the memory allocator, the first memory access request when the authentication result indicates that the authentication succeeds, and rejecting the first memory access request when the authentication result indicates that the authentication fails.

In addition, as described above, in some embodiments, the device driving module disables the protection rule of the target partition when the authentication result indicates that the authentication succeeds; therefore, memory access requests from trusted users are not restricted by the protection rule. When the memory allocator finishes executing the first memory access request and notifies the trusted driving module, the trusted driving module is configured to invoke the interface of the device driving module again, to read and store the updated second key stored in the secure memory module and notify the device driving module to re-enable the protection rule of the target partition. That is, each time the memory allocator completes the first memory access request, the device driving module re-enables the protection rule, and the second key is updated, enhancing system security.

As can be seen from FIG. 1C, unauthorized users may attempt to access the target partition through two pathways. A first pathway involves sending the first memory access request to the memory allocator by an access path corresponding to unauthorized user 2 (as shown in FIG. 1C). The first pathway requires authentication, and the first memory access request is executed only if the user is confirmed as trusted (i.e., trusted user). A second pathway involves bypassing the memory allocator and directly accessing the target partition by an access path corresponding to unauthorized user 1 (as shown in FIG. 1C). As the operating system cannot access the physical memory partitions managed by the memory allocator, the second pathway requires unauthorized users to obtain system administrator privileges. For the second pathway, when key matching occurs, if the user fails to undergo identity authentication and cannot obtain the first key, the system will not disable the protection rule by key matching; that is, the protection rule for the target partition remains enabled, preventing unauthorized users from accessing the target partition freely and further enhancing data security within the target partition. FIG. 4 illustrates a flowchart of unauthorized users bypassing the memory allocator to directly access the target partition.

Step S41 includes detecting, by the secure memory module, whether a conflict exists between a second memory access request and the protection rule for the target partition. The second memory access request is not from the memory allocator. If a conflict exists between the second memory access request and the protection rule, the secure memory module proceeds to step S42; and if no conflict exists between the second memory access request and the protection rule, the secure memory module proceeds to step S43.

In some embodiments, based on the protection rule enabling the target partition, operations that can be performed on the target partition may be regarded as first operations; and based on the second memory access request, operations that users wish to be performed on the target partition may be regarded as second operations. In step S41, whether a conflict exists between the second memory access request and the protection rule can be determined based on the first and second operations; in other words, if the second operations are comprised in the first operations, it is determined that the second memory access request does not conflict with the protection rule; and if the second operations are not comprised in the first operations, it is determined that the second memory access request conflicts with the protection rule. In some other embodiments, operations corresponding to the second memory access request can be directly compared with the protection rule for the target partition, to determine whether a conflict exists between the second memory access request and the protection rule.

Step S42 includes rejecting the second memory access request and generating an illegal access record, by the secure memory module.

Step S43 includes executing, by the secure memory module, the second memory access request.

Specifically, when the unauthorized users bypass the memory allocator and directly access the target partition, and the protection rule for the target partition is in an enabled state, the secure memory module is configured to reject the second memory access request and generate the illegal access record when detecting that the conflict exists. For example, if the second memory access request aims to perform a write operation on a target partition, and the protection rule for the target partition is to disable read and write, the second memory access request conflicts with the protection rule, and the secure memory module rejects the second memory access request and generates the illegal access record.

In some embodiments, the illegal access record may be periodically read and reported by the device driving module, or may be reported in real-time. Additionally, an interface can be provided for administrators. After reading the illegal access record, the device driving module can promptly notify the administrators through this interface.

In one embodiment of the present disclosure, the target partition is invisible to the operating system, and the memory allocator completely controls the target partition. In this way, memory spaces used by different programs can be effectively isolated, preventing conflicts or interference between programs, during which time malicious programs can be prevented from illegally accessing or modifying the memory spaces, ensuring the security of the operating system.

In one embodiment of the present disclosure, the first and second memory access requests comprise memory allocation requests, memory release requests, memory mapping requests, memory data attribute modification requests, and/or memory data read/write requests.

The memory allocator is a program module for dynamically allocating the memory spaces, and the physical memory partitions managed by the memory allocator can be allocated to the applications for use, based on user requests, so as to meet memory needs of the applications. In some embodiments, the memory allocator divides its physical memory into a plurality of physical memory partitions with different sizes, and maintains an allocation status table of the plurality of physical memory partitions. When an application requires memory allocation, the memory allocator searches the allocation status table for available physical memory partitions and allocates them to the application for use. When the application releases its physical memory, the memory allocator reclaims the released physical memory and adds them back to the allocation status table for future allocations.

The memory release requests are configured to release physical memories of the target partition. Specifically, when receiving a legitimate memory release request, the memory allocator releases one of the physical memories of a corresponding target partition that has been allocated out, into the available physical memories of the target partition.

The memory mapping requests are configured to map the physical memories of the target partition. Specifically, when receiving a legitimate memory mapping request, the memory allocator maps data of files in the corresponding physical memory partition into address spaces of processes (such as process 1 and process 2). The memory data attribute modification requests are configured to modify attributes of data in the target partition. When receiving a legitimate memory data attribute modification request, the memory allocator modifies the corresponding management data.

The memory data read/write requests are configured to perform a read operation or a write operation on the data in the target partition.

The scope of the method for managing the memory described in the present disclosure is not limited to the sequence of operations listed herein. Any scheme realized by adding or subtracting operations or replacing operations of the traditional techniques according to the principle of the present disclosure is included in the scope of the present disclosure.

The present disclosure further provides a system for managing a memory. The system comprises a memory allocator and a trusted driving module. The memory allocator is configured to receive a first memory access request for a target partition of the memory and obtain authentication information to generate an authentication request. The memory allocator manages one or more physical memory partitions of the memory, and the target partition is one of the physical memory partitions. The trusted driving module is configured to receive the authentication request, generate an authentication result based on the authentication information and external authorization information, and return the authentication result to the memory allocator. The memory allocator is further configured to execute the first memory access request when the authentication result indicates that the authentication succeeds, and reject the first memory access request when the authentication result indicates that the authentication fails.

In some embodiments, the system further comprises a device driving module and a secure memory module. The secure memory module is a hardware module, and the device driving module is a software driving module corresponding to the secure memory module. The device driving module configures a protection rule for each of the physical memory partitions to limit access to the physical memory partitions.

In some embodiments, the trusted driving module is further configured to invoke an interface of the device driving module and send a first key stored in the trusted driving module to the device driving module when the authentication result indicates that the authentication succeeds. The device driving module is configured to determine if the first key matches a second key stored in the secure memory module, and disable a protection rule of the target partition when the first key matches the second key.

In some embodiments, the secure memory module is further configured to update the second key after the first key matches the second key, to obtain updated second key.

In some embodiments, the trusted driving module is further configured to invoke the interface of the device driving module after the memory allocator finishes executing the first memory access request, to notify the device driving module to re-enable the protection rule of the target partition, and update the first key based on the updated second key.

In some embodiments, the system further comprises a secure memory module. The secure memory module is configured to receive a second memory access request for the target partition, detect whether a conflict exists between the second memory access request and the protection rule of the target partition, and reject the second memory access request when detecting that the conflict exists. The second memory access request is not from the memory allocator.

In some embodiments, the secure memory module is further configured to generate an illegal access record when detecting that the conflict exists.

In some embodiments, the protection rules comprise one or more of: data reads from the physical memory partition are disabled, data writes to the physical memory partition are disabled, and accesses to the physical memory partition are monitored.

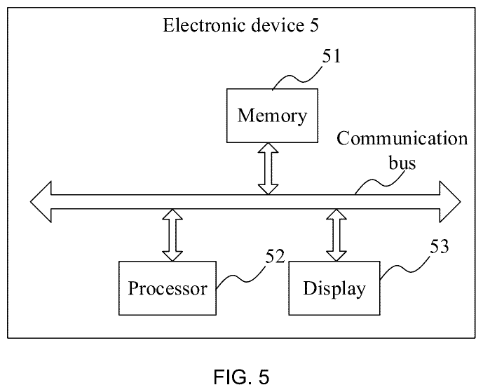

The present disclosure further provides an electronic device 5. FIG. 5 shows a schematic diagram of the electronic device 5. As shown in FIG. 5, the electronic device 5 comprises a memory 51 and a processor 52.

The memory 51 is configured to store a computer program. Preferably, the memory 51 comprises various medium that may store program codes, such as ROMs, RAMs, magnetic disks, USB flash disks, memory cards, or optical disks.

Specifically, the memory 51 may comprise a volatile computer-readable storage medium, such as RAM and/or cache memory. The electronic device 5 may further comprise other removable/non-removable, volatile/nonvolatile computer system storage media. The memory 51 may comprise at least one program product, and the program product has a group of (for example, at least one) program modules, and these program modules are configured to implement the functions of the embodiments of the present disclosure.

The processor 52 is connected to the memory 51 for executing the computer program stored in the memory 51 to cause the electronic device 5 to perform the method for managing the memory described above.

Optionally, the processor 52 may be a general processor, including a central processing unit (CPU), a network processor (NP), etc.; it may also be a digital signal processor (DSP), application specific integrated circuit (ASIC), field programmable gate array (FPGA) or other programmable logic devices.

Optionally, the electronic device 5 may further comprises a display 53. The display 53 is communicatively connected to the memory 51 and the processor 52 for displaying an interface related to the method for managing the memory.

The present disclosure introduces the concept of “partition” management, where a specific portion of physical memory is managed separately. By implementing protection rules, identity authentication, and encryption keys, the data stored in this specific memory region (referred to as the target partition) benefits from both software and hardware-based security mechanisms, preventing unauthorized users from accessing or modifying the data. Additionally, any unauthorized access attempts can be monitored and recorded. Overall, this strategy transforms the memory devices from passive components to actively secured elements, significantly enhancing memory security.

The above-mentioned embodiments only exemplarily illustrate the principles and effects of the present disclosure, but are not used to restrict the present disclosure. Any person skilled in the art may modify or change the above embodiments without violating the spirit and scope of the present disclosure. Therefore, all equivalent modifications or changes made by those skilled in the art without departing from the spirit and technical concepts disclosed by the present disclosure should still be covered by the attached claims of the present disclosure.

1. A system for managing a memory, comprising:
a memory allocator, configured to receive a first memory access request for a target partition of the memory and obtain authentication information to generate an authentication request, wherein the memory allocator manages one or more physical memory partitions of the memory, and the target partition is one of the physical memory partitions; and
a trusted driving module, configured to receive the authentication request, generate an authentication result based on the authentication information and external authorization information, and return the authentication result to the memory allocator;
wherein the memory allocator is further configured to execute the first memory access request when the authentication result indicates that the authentication succeeds, and reject the first memory access request when the authentication result indicates that the authentication fails.

2. The system according to claim 1, further comprising a device driving module, wherein the device driving module configures a protection rule for each of the physical memory partitions to limit access to the physical memory partitions.

3. The system according to claim 2, further comprising a secure memory module, wherein
the trusted driving module is further configured to invoke an interface of the device driving module and send a first key stored in the trusted driving module to the device driving module when the authentication result indicates that the authentication succeeds;
the device driving module is configured to determine if the first key matches a second key stored in the secure memory module, and disables a protection rule of the target partition when the first key matches the second key.

4. The system according to claim 3, wherein the secure memory module is further configured to update, after the first key matches the second key, the second key to obtain an updated second key.

5. The system according to claim 4, wherein the trusted driving module is further configured to invoke the interface of the device driving module after the memory allocator finishes executing the first memory access request to notify the device driving module to re-enable the protection rule of the target partition, and update the first key based on the updated second key.

6. The system according to claim 2, further comprising a secure memory module, wherein the secure memory module is configured to receive a second memory access request for the target partition, detect whether a conflict exists between the second memory access request and a protection rule of the target partition, and reject the second memory access request when detecting that the conflict exists, wherein the second memory access request is not from the memory allocator.

7. The system according to claim 6, wherein the secure memory module is further configured to generate an illegal access record when detecting that the conflict exists.

8. The system according to claim 2, wherein the protection rules comprise one or more of:
data reads from the physical memory partition are disabled,
data writes to the physical memory partition are disabled, and
accesses to the physical memory partition are monitored.

9. A method applied to a system for managing a memory, wherein the system comprises a memory allocator and a trusted driving module, wherein the memory allocator manages one or more physical memory partitions of the memory, and the method comprises:
receiving, by the memory allocator, a first memory access request for a target partition and obtaining authentication information to generate an authentication request, wherein the target partition is one of the physical memory partitions;
sending, by the memory allocator, the authentication request to the trusted driving module;
generating, by the trusted driving module, an authentication result based on the authentication information of the authentication request and external authorization information, and returning the authentication result to the memory allocator; and
executing, by the memory allocator, the first memory access request when the authentication result indicates that the authentication succeeds, and rejecting the first memory access request when the authentication result indicates that the authentication fails.

10. The method according to claim 9, wherein the system further comprises a device driving module, and the method further comprises:
configuring, by the device driving module, a protection rule for each of the physical memory partitions to limit access to the physical memory partitions.

11. The method according to claim 10, wherein the system further comprises a secure memory module, and the method further comprises:
invoking, by the trusted driving module, an interface of the device driving module and sending a first key stored in the trusted driving module to the device driving module when the authentication result indicates that the authentication succeeds; and
determining, by the device driving module, if the first key matches a second key stored in the secure memory module, and closing a protection rule of the target partition when the first key matches the second key.

12. The method according to claim 11, further comprising:
updating, by the secure memory module, the second key to obtain an updated second key after the first key matches the second key.

13. The method according to claim 12, further comprising:
invoking, by the trusted driving module, the interface of the device driving module after the memory allocator finishes executing the first memory access request to notify the device driving module to re-enable the protection rule of the target partition, and updating the first key based on the updated second key.

14. The method according to claim 10, wherein the system further comprises a secure memory module, and the method further comprises:
receiving, by the secure memory module, a second memory access request for the target partition, detecting whether a conflict exists between the second memory access request and a protection rule of the target partition, and rejecting the second memory access request when detecting that the conflict exists, wherein the second memory access request is not from the memory allocator.

15. The method according to claim 14, further comprising:
generating, by the secure memory module, an illegal access record when detecting that the conflict exists.

16. An electronic device, comprising:
a memory, on which a computer program is stored; and
a processor, communicatively connected to the memory and configured to invoke the computer program to perform a method applied to a system for managing the memory,
wherein the system comprises a memory allocator and a trusted driving module, the memory allocator manages one or more physical memory partitions of the memory, and the method comprises:
receiving, by the memory allocator, a first memory access request for a target partition and obtaining authentication information to generate an authentication request, wherein the target partition is one of the physical memory partitions;
sending, by the memory allocator, the authentication request to the trusted driving module;
generating, by the trusted driving module, an authentication result based on the authentication information of the authentication request and external authorization information, and returning the authentication result to the memory allocator; and
executing, by the memory allocator, the first memory access request when the authentication result indicates that the authentication succeeds, and rejecting the first memory access request when the authentication result indicates that the authentication fails.
